(19) United States
(12) Patent Application Publication
(10) Pub. No.: US 2017/0320447 A1
(43) Pub. Date: Nov. 9, 2017

(54) Motorcycle Transport Assembly

(71) Applicant: Rodney Dunlap, Sacramento, CA (US)

(72) Inventor: Rodney Dunlap, Sacramento, CA (US)

(21) Appl. No.: 15/146,434

(22) Filed: May 4, 2016

(51) Int. Cl. B60R 9/10; B60P 3/077; B60P 1/64; B60R 9/06; B60P 1/02

(52) U.S. Cl. CPC B60R 9/10; B60R 9/06; B60P 1/02; B60P 1/6409; B60P 3/077

(57) ABSTRACT

A motorcycle transport assembly includes a lift that may be removably coupled to a hitch on a vehicle. A rack is removably coupled to the lift and the lift selectively lifts and lowers the rack. Thus, the rack may be selectively lowered onto and lifted upwardly from a support surface. The rack may support a motorcycle thereby facilitating the vehicle to transport the motorcycle when the rack is lifted upwardly from the support surface.

### BACKGROUND OF THE INVENTION

### (1) Field of the Invention

### (2) Description of Related Art Including Information Disclosed Under 37 CFR 1.97 and 1.98

The disclosure relates to transport devices and more particularly pertains to a new transport device for transporting a motorcycle with a vehicle.

### BRIEF SUMMARY OF THE INVENTION

An embodiment of the disclosure meets the needs presented above by generally comprising a lift that may be removably coupled to a hitch on a vehicle. A rack is removably coupled to the lift and the lift selectively lifts and lowers the rack. Thus, the rack may be selectively lowered onto and lifted upwardly from a support surface. The rack may support a motorcycle thereby facilitating the vehicle to transport the motorcycle when the rack is lifted upwardly from the support surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a motorcycle transport assembly according to an embodiment of the disclosure.

FIG. 2 is a front view of an embodiment of the disclosure.

FIG. 3 is a right side view of an embodiment of the disclosure.

FIG. 4 is a cross sectional view taken along line 4-4 of FIG. 3 of an embodiment of the disclosure.

FIG. 5 is a perspective in-use view of an embodiment of the disclosure.

### DETAILED DESCRIPTION OF THE INVENTION

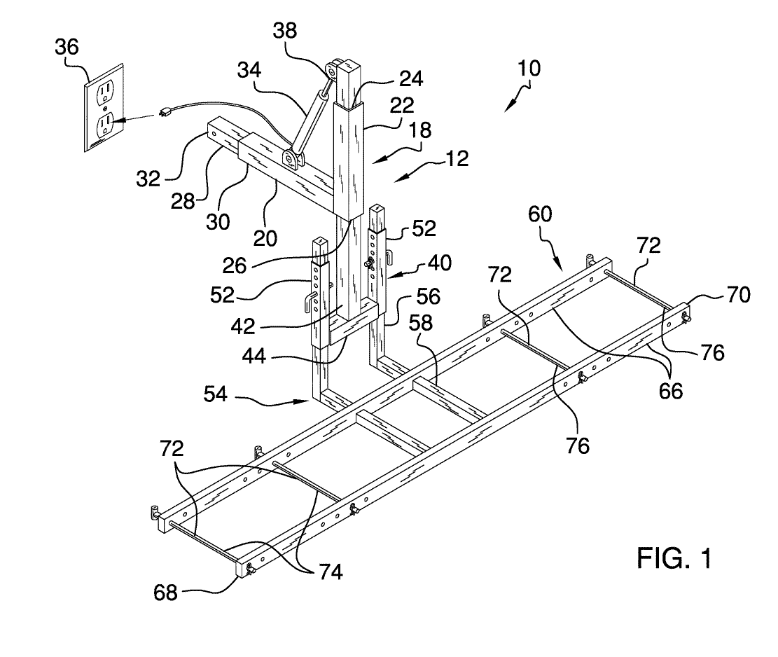

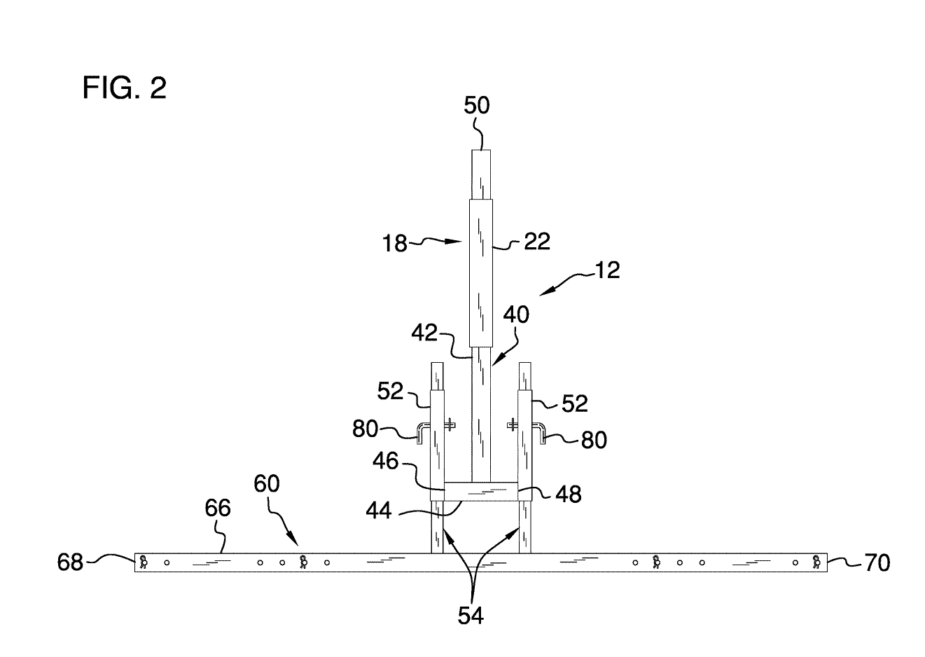

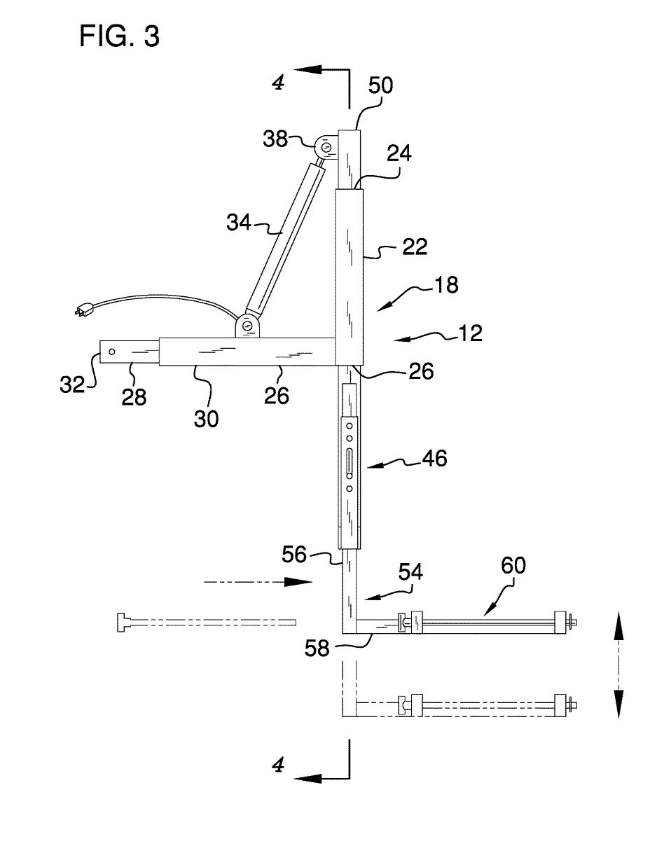

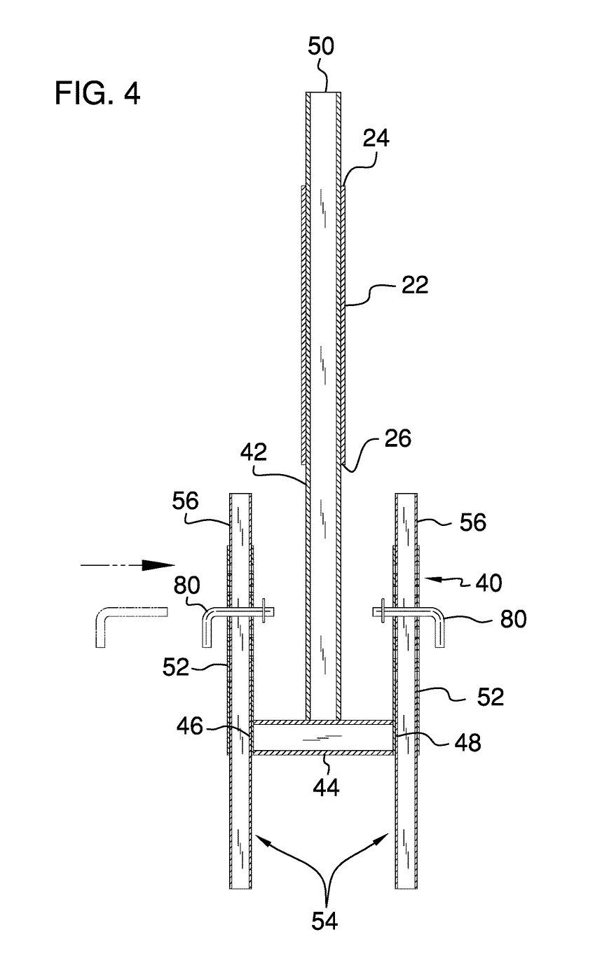

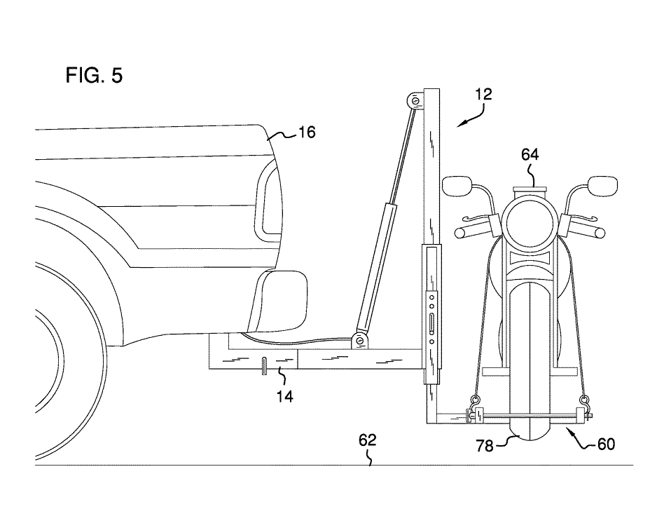

With reference now to the drawings, and in particular to FIGS. 1 through 5 thereof, a new transport device embodying the principles and concepts of an embodiment of the disclosure and generally designated by the reference numeral 10 will be described.

As best illustrated in FIGS. 1 through 5, the motorcycle transport assembly 10 generally comprises a lift 12 that may be removably coupled to a hitch 14 on a vehicle 16. The vehicle 16 may be a passenger vehicle or the like. The lift 12 includes a mount 18 that comprises a first tube 20 coupled to a second tube 22. The first tube 20 is oriented perpendicular to the second tube 22 and the second tube 22 has a first end 24 and a second end 26. Each of the first end 24 and the second end 26 is open.

The first tube 20 has a first section 28 that is slidably coupled to a second section 30 such that the first tube 20 has a telescopically adjustable length. The first section 28 has a distal end 32 with respect to the second section 30. The distal end 32 may be inserted into the hitch 14 thereby facilitating the mount 18 to be removably coupled to the hitch 14. The second tube 22 is vertically oriented when the mount 18 is removably coupled to the hitch 14. Moreover, the second tube 22 may be spaced a selected distance from the vehicle 16 when the first tube 20 is coupled to the hitch 14.

A piston 34 is coupled to the second section 30 of the first tube 20. The piston 34 may be electrically coupled to a power source 36. The power source 36 may be an electrical outlet of the like. The piston 34 has a distal end 38 with respect to the first tube 20. The piston 34 may comprise an electrically actuated piston or the like.

A support 40 is slidably coupled to the mount 18 and the support 40 is coupled to the piston 34. Thus, the piston 34 selectively urges the support 40 upwardly and downwardly in the mount 18. The support 40 comprises a primary member 42 that is coupled to a secondary member 44. The primary member 42 is oriented parallel to the secondary member 44 such that the primary member 42 and the secondary member 44 forms a T-shape. The primary member 42 is centrally positioned on the secondary member 44.

The secondary member 44 has a first end 46 and a second end 48. The primary member 42 has a distal end 50 with respect to the secondary member 44. The primary member 42 extends through the second end 48 and the first end 46 of the second tube 48. The distal end 50 of the primary member 42 is spaced from the first end 46 of the second tube 22. The distal end 38 of the piston 34 is coupled to the primary member 42 adjacent to the distal end 50 of the primary member 42. Thus, the piston 34 selectively urges the primary member 42 upwardly and downwardly in the second tube 22.

The support 40 further includes a pair of third tubes 52. Each of the third tubes 52 is coupled to an associated one of the first end 46 and the second end 48 of the secondary member 44. Each of the third tubes 52 is oriented to be coextensive with the primary member 42. Additionally, each of the third tubes 52 extends toward the distal end 50 of the primary member 42.

A pair of forks 54 is provided. Each of the forks 54 slidably engages an associated one of the third tubes 52. Each of the forks 54 includes a leg 56 and a foot 58. The leg 56 corresponding to each of the forks 54 slidably engages the associated third tube 52.

A rack 60 is removably coupled to the lift 12 such that the lift 12 selectively lifts and lowers the rack 60. Thus, the rack 60 may be selectively lowered onto and lifted upwardly from a support surface 62. The support surface 62 may be ground. A motorcycle 64 may be positioned on the rack 60. Thus, the vehicle 16 may transport the motorcycle 64 when the rack 60 is lifted upwardly from the support surface 62.

The rack 60 includes a pair of rails 66 each having a primary end 68 and a secondary end 70. Each of the rails 66 is coupled to the foot 58 corresponding to an associated one of the forks 54. Thus, the rails 60 are spaced apart from each other. Moreover, each of the rails 66 is oriented perpendicular to the forks 54.

A plurality of rods 72 is provided and each of the rods 72 removably extends between the rails 66. The plurality of rods 72 includes a pair of first rods 74 and a pair of second of rods 76. Each of the first rods 74 is positioned closer to the primary end 68 than the secondary end 70. Each of the first rods 74 is spaced a selected distance apart from each other. Thus, an associated wheel 78 of the motorcycle 64 may be positioned to rest on the first rods 74 thereby facilitating the first rods 74 to support the associated wheel 78. The first rods 74 are spaced a selected distance apart to accommodate varying sizes of wheels 78.

Each of the second rods 76 is positioned closer to the secondary end 70 than the primary end 68. Each of the second rods 76 is spaced a selected distance apart from each other. Thus, an associated wheel 78 of the motorcycle 64 may be positioned to rest on the second rods 76 thereby facilitating the second rods 76 to support the associated wheel 78. The second rods 76 are spaced a selected distance apart to accommodate varying sizes of wheels 78. Each of the rails 66 is coupled to the foot 58 corresponding to each of the forks 54. The rack 60 supports the motorcycle 64 when the motorcycle 64 is positioned on the first rods 74 and the second rods 76. Thus, the lift 12 may lift the motorcycle 64 upwardly from the support surface 62.

Each of the first rods 74 and each of the second rods 76 may include a knob. The knob may inhibit each of the first rods 74 and the second rods 76 from being passed through the rails 66. A plurality of cotter pins may be provided. Each of the cotter pins may be extended through an associated one of the rods 72 when the rods 72 are extended through the rails 66. Thus, each of the cotter pins may inhibit the rods 72 from being removed from the rails 66.

A pair of pins 80 is provided and each of the pins 80 may be manipulated. Each of pins 80 extends through an associated one of the third tubes 52. Each of the pins 80 may be positioned at a selected point along the associated third tube 52. Each of the pins 80 engages the leg 56 of an associated one of the forks 54. Thus, the rack 66 is retained at a selected height with respect to the support 40.

Each of the third tubes 52 may have a plurality of openings extending therethrough. The openings corresponding to each third tube 52 may be spaced apart from each other. Additionally, the openings may be distributed along the corresponding third tube 52. Each of the pins 80 may be positioned in a selected one of the openings in the corresponding third tube 52.

A plurality of straps may be provided. Each of the straps may be coupled between the motorcycle 64 and the rack 60 when the motorcycle 64 is positioned on the rack 60. Thus, the motorcycle 64 is inhibited from tipping off the rack 60. Each of the straps may be ratchet straps or the like.

In use, the lift 12 is coupled to the hitch 14 and the piston 34 is electrically coupled to the power source 36. The pins 80 are manipulated to position each of the forks 54 at a selected point on the support 40. The piston 34 is actuated to lower the rack 60 onto the support surface 62 and the motorcycle 64 is positioned on the rack 60. The straps are manipulated to tie the motorcycle 64 to the rack 60. The piston 34 is actuated to raise the rack 60 upwardly from the support surface 62 and the vehicle 16 is driven to transport the motorcycle 64.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A motorcycle transport assembly being configured to be coupled to a vehicle thereby facilitating the vehicle to transport a motorcycle, said assembly comprising:
a lift being configured to be removably coupled to a hitch on a vehicle, said lift comprising a mount having a first tube being coupled to a second tube, said first tube being oriented perpendicular to said second tube, said second tube having a first end and a second end, each of said first end and said second end being open, said first tube comprising a first section being slidably coupled to a second section such that said first tube has a telescopically adjustable length, said first section having a distal end with respect to said second section, said distal end being configured to be inserted into the hitch thereby facilitating said mount to be removably coupled to the hitch, said second tube being vertically oriented when said mount is removably coupled to the hitch;
a piston being coupled to said second section of said first tube, said piston being configured to be electrically coupled to a power source, said piston having a distal end with respect to said first tube;
a support being slidably coupled to said mount, said support being coupled to said piston such that said piston selectively urges said support upwardly and downwardly in said mount, said support comprising a primary member being coupled to a secondary member, said primary member being oriented perpendicular to said secondary member such that said primary member and said secondary member forms a T-shape, said primary member being centrally positioned on said secondary member, said secondary member having a first end and a second end, said primary member having a distal end with respect to said secondary member;
a pair of third tubes, each of said third tubes being coupled to an associated one of said first end and said second end of said secondary member, each of said third tubes being coextensive with said primary member such that each of said third tubes extends toward said distal end of said primary member;
a rack being removably coupled to said lift such that said lift selectively lifts and lowers said rack wherein said rack is configured to be selectively lowered onto and lifted upwardly from a support surface, said rack being configured to support a motorcycle thereby facilitating the vehicle to transport the motorcycle when said rack is lifted upwardly from the support surface; and
a fork, each of said forks slidably engaging an associated one of said third tubes, each of said forks including a leg and a foot, said leg corresponding to each of said forks slidably engaging said associated third tube.

2. (canceled)

3. (canceled)

4. (canceled)

5. (canceled)

6. (canceled)

7. The assembly according to claim 1, wherein said primary member extends through said second end and said first end of said second tube having said distal end of said primary member being spaced from said first end of said second tube, said distal end of said piston being coupled to said primary member adjacent to said distal end of said primary member such that said piston selectively urges said primary member upwardly and downwardly in said second tube.

8. (canceled)

9. (canceled)

10. The assembly according to claim 1, wherein:
said lift includes a pair of forks, each of said forks having a foot; and
said rack comprises a pair of rails, each of said rails having a primary end and a secondary end, each of said rails being coupled to said foot corresponding to an associated one of said forks such that said rails are spaced apart from each other having each of said rails being oriented perpendicular to said forks.

11. The assembly according to claim 10, further comprising a plurality of rods, each of said rods removably extending between said rails, said plurality of rods including a pair of first rods and a pair of second rods.

12. The assembly according to claim 11, wherein each of said first rods is positioned closer to said primary end than said secondary end, each of said first rods being spaced a selected distance apart from each other wherein each of said first rods is configured to have an associated wheel of the motorcycle being positioned between said first rods thereby facilitating said first rods to support the associated wheel.

13. The assembly according to claim 11, wherein each of said second rods is positioned closer to said secondary end than said primary end, each of said second rods being spaced a selected distance apart from each other wherein each of said second rods is configured to have an associated wheel of the motorcycle being positioned between said second rods thereby facilitating said second rods to support the associated wheel.

14. A motorcycle transport assembly being configured to be coupled to a vehicle thereby facilitating the vehicle to transport a motorcycle, said assembly comprising:
a lift being configured to be removably coupled to a hitch on a vehicle, said lift comprising a mount having a first tube being coupled to a second tube, said first tube being oriented perpendicular to said second tube, said second tube having a first end and a second end, each of said first end and said second end being open, said first tube comprising a first section being slidably coupled to a second section such that said first tube has a telescopically adjustable length, said first section having a distal end with respect to said second section, said distal end being configured to be inserted into the hitch thereby facilitating said mount to be removably coupled to the hitch, said second tube being vertically oriented when said mount is removably coupled to the hitch;
a piston being coupled to said second section of said first tube, said piston being configured to be electrically coupled to a power source, said piston having a distal end with respect to said first tube;
a support being slidably coupled to said mount, said support being coupled to said piston such that said piston selectively urges said support upwardly and downwardly in said mount, said support comprising a primary member being coupled to a secondary member, said primary member being oriented parallel to said secondary member such that said primary member and said secondary member forms a T-shape, said primary member being centrally positioned on said secondary member, said secondary member having a first end and a second end, said primary member having a distal end with respect to said secondary member;
a pair of third tubes, each of said third tubes being coupled to an associated one of said first end and said second end of said secondary member, each of said third tubes being coextensive with said primary member such that each of said third tubes extends toward said distal end of said primary member;
a rack being removably coupled to said lift such that said lift selectively lifts and lowers said rack wherein said rack is configured to be selectively lowered onto and lifted upwardly from a support surface, said rack being configured to support a motorcycle thereby facilitating the vehicle to transport the motorcycle when said rack is lifted upwardly from the support surface;
a pair of forks, each of said forks having a leg; and
a pair of pins, each of said pins being configured to be manipulated, each of pins extending through an associated one of said third tubes at a selected point along said associated third tube, each of said pins engaging said leg of an associated one of said forks such that said rack is retained at a selected height with respect to said support.

15. A motorcycle transport assembly being configured to be coupled to a vehicle thereby facilitating the vehicle to transport a motorcycle, said assembly comprising:
a lift being configured to be removably coupled to a hitch on a vehicle, said lift comprising:
a mount having a first tube being coupled to a second tube, said first tube being oriented perpendicular to said second tube, said second tube having a first end and a second end, each of said first end and said second end being open, said first tube comprising a first section being slidably coupled to a second section such that said first tube has a telescopically adjustable length, said first section having a distal end with respect to said second section, said distal end being configured to be inserted into the hitch thereby facilitating said mount to be removably coupled to the hitch, said second tube being vertically oriented when said mount is removably coupled to the hitch,
a piston being coupled to said second section of said first tube, said piston being configured to be electrically coupled to a power source, said piston having a distal end with respect to said first tube, and
a support being slidably coupled to said mount, said support being coupled to said piston such that said piston selectively urges said support upwardly and downwardly in said mount, said support comprising:
a primary member being coupled to a secondary member, said primary member being oriented perpendicular to said secondary member such that said primary member and said secondary member forms a T-shape, said primary member being centrally positioned on said secondary member, said secondary member having a first end and a second end, said primary member having a distal end with respect to said secondary member, said primary member extending through said second end and said first end of said second tube having said distal end of said primary member being spaced from said first end of said second tube, said distal end of said piston being coupled to said primary member adjacent to said distal end of said primary member such that said piston selectively urges said primary member upwardly and downwardly in said second tube, and
a pair of third tubes, each of said third tubes being coupled to an associated one of said first end and said second end of said secondary member, each of said third tubes being coextensive with said primary member such that each of said third tubes extends toward said distal end of said primary member;
a pair of forks, each of said forks slidably engaging an associated one of said third tubes, each of said forks including a leg and a foot, said leg corresponding to each of said forks slidably engaging said associated third tube; and
a rack being removably coupled to said lift such that said lift selectively lifts and lowers said rack wherein said rack is configured to be selectively lowered onto and lifted upwardly from a support surface, said rack being configured to support a motorcycle thereby facilitating the vehicle to transport the motorcycle when said rack is lifted upwardly from the support surface, said rack comprising:
a pair of rails, each of said rails having a primary end and a secondary end, each of said rails being coupled to said foot corresponding to an associated one of said forks such that said rails are spaced apart from each other having each of said rails being oriented perpendicular to said forks,
a plurality of rods, each of said rods removably extending between said rails, said plurality of rods including a pair of first rods and a pair of second rods, each of said first rods being positioned closer to said primary end than said secondary end, each of said first rods being spaced a selected distance apart from each other wherein each of said first rods is configured to have an associated wheel of the motorcycle being positioned between said first rods thereby facilitating said first rods to support the associated wheel, each of said second rods being positioned closer to said secondary end than said primary end, each of said second rods being spaced a selected distance apart from each other wherein each of said second rods is configured to have an associated wheel of the motorcycle being positioned between said second rods thereby facilitating said second rods to support the associated wheel, wherein said rack is configured to support the motorcycle when the motorcycle is positioned on said first rods and said second rods thereby facilitating said lift to lift the motorcycle upwardly from the support surface; and
a pair of pins, each of said pins being configured to be manipulated, each of pins extending through an associated one of said third tubes at a selected point along said associated third tube, each of said pins engaging said leg of an associated one of said forks such that said rack is retained at a selected height with respect to said support.
